(19) United States
(12) Patent Application Publication
(10) Pub. No.: US 2017/0348980 A1
(43) Pub. Date: Dec. 7, 2017

(54) THERMAL PRINTHEAD TEMPERATURE CONTROL

(71) Applicant: Datamax-O'Neil Corporation, Orlando, FL (US)

(72) Inventor: Zhiyong Liu, Singapore (SG)

(21) Appl. No.: 15/169,991

(22) Filed: Jun. 1, 2016

(51) Int. Cl. B41J 2/375

(52) U.S. Cl. CPC B41J 2/375

(57) ABSTRACT

Control of the print temperature for a thermal printer is disclosed. Two temperature sensors are used to sense the temperature of both the thermal printhead and the environment around the print medium. In this way, the energy applied to the thermal printhead's heating elements may be adjusted to match an ideal print temperature, which depends on both the printhead temperature and the print-medium temperature.

### FIELD OF THE INVENTION

The present invention relates to thermal printers and more specifically, to controlling the heating of a thermal printhead based on temperatures measured at the thermal printhead and away from the thermal printhead.

### BACKGROUND

A typical thermal printhead uses a temperature sensor (e.g., thermistor) integrated with the thermal printhead to measure a printhead temperature. The printhead temperature is used to control the energy applied to the thermal printhead for heating during printing. For example, as the thermal printhead becomes hot during printing, the energy applied to the thermal printhead may be reduced. Reducing the heating, however, may affect print quality, especially if the print medium (e.g., thermal paper) is cold (e.g., in a cold environment).

To insure high-quality thermal printing, both the temperature of the printhead and the temperature of the environment should be used for print-temperature control. In this way, when the printhead temperature and the environment temperature diverge, the heating of the thermal printhead may be compensated so that the print quality does not suffer.

Therefore, a need exists for a thermal printer that monitors both a printhead temperature and an environment temperature and that can adapt its heating to maintain print quality when the printhead temperature and the environment temperature differ.

### SUMMARY

Accordingly, in one aspect, the present invention embraces a thermal printer. The thermal printer includes a thermal printhead with an array of heating elements that are positioned close to a print-medium path. A print-medium subsystem is also included as part of the thermal printer. The print-medium path includes a spool for holding a print medium and a movement mechanism for moving the print medium off the spool and along the print-medium path so that the print medium may be heated by the array of heating elements. The thermal printer also includes a housing to contain/support the thermal printhead and the print-medium subsystem and two sensors (a printhead sensor and an environment sensor) to measure temperature. Both sensors are contained in the housing. The first sensor (e.g., a printhead sensor) is contiguous to the thermal printhead and measures a printhead temperature. The second sensor (e.g., an environment sensor) is positioned apart from the thermal printhead and measures an environment temperature. A processor, also contained in the housing, is communicatively coupled to the thermal printhead, the printhead sensor, and the environment sensor. The processor is configured by software to compare the environment temperature and the printhead temperature. The processor is further configured to compute a temperature value (e.g., a compensated temperature) based on the comparison, and to control the heating of the array of heating elements using the temperature value.

In an exemplary embodiment of the thermal printer, the control of the heating of the array of heating elements includes adjusting the energy applied to the heating elements to minimize the difference between the compensated temperature and a set-point temperature. In one possible embodiment, the set-point temperature corresponds to characteristics of the print-medium subsystem and the print medium. For example, the characteristics of the print medium subsystem and the print medium include the speed at which the print medium moves along the print-medium path and/or the thermal sensitivity of the print medium.

In another exemplary embodiment of the thermal printer, the environment sensor is positioned proximate to the spool.

In another exemplary embodiment of the thermal printer, the environment temperature is approximately the temperature of the print medium.

In another exemplary embodiment of the thermal printer, the print medium is thermal paper.

In another exemplary embodiment of the thermal printer, the printhead sensor and the environment sensor are thermistors.

In another exemplary embodiment, comparing the environment temperature to the printhead temperature includes calculating a temperature gap, which is the difference between the environment temperature and the printhead temperature. For the case in which the temperature gap is below a temperature-gap threshold, the processor is configured to compute a compensated temperature by using the printhead temperature as the compensated temperature. For the case in which (i) the temperature gap is above a temperature-gap threshold and (ii) the environment temperature is greater than the printhead temperature, the processor is configured to compute a compensated temperature by adding a compensation value to the printhead temperature. For the case in which (i) the temperature gap is above a temperature-gap threshold and (ii) the environment temperature is less than the printhead temperature, the processor is configured to compute a compensated temperature by subtracting a compensation value from the printhead temperature.

In another aspect, the present invention embraces a print-temperature control system for a thermal printer. The system includes a printhead sensor that is mounted on the thermal printer's printhead and an environment sensor mounted away from the printhead. The printhead sensor measures a printhead temperature and the environment sensor measures an environment temperature. The system also includes a processor that is communicatively coupled to the printhead sensor and the environment sensor. The processor is configured by software to compare the environment temperature and the printhead temperature. Based on this comparison, the processor is configured to create a compensated temperature, and to use this compensated temperature to adjust the energy applied to the thermal printer's printhead.

In an exemplary embodiment of the print-temperature control system, the comparison of the environment temperature to the printhead temperature includes computing a temperature gap, which is the difference between the environment temperature and the printhead temperature.

In one possible embodiment of the print-temperature control system, the compensated temperature is computed to equal the printhead temperature if the temperature gap is below a temperature-gap threshold.

In another possible embodiment of the print-temperature control system, the compensated temperature is computed to not equal the printhead temperature if the temperature gap is above a temperature-gap threshold. For the case in which (i) the temperature gap is above a threshold temperature and (ii) the environment temperature is greater than the printhead temperature, then, in one possible embodiment, the compensated temperature is computed to be greater than the printhead temperature. For the case in which (i) the temperature gap is above a threshold temperature and (ii) the environment temperature is less than the printhead temperature, then, in one possible embodiment, the compensated temperature is computed to be less than the printhead temperature.

In another aspect, the present invention embraces a method for controlling the print temperature of a thermal printhead. The method includes providing a thermal printer. The thermal printer includes (i) a thermal printhead to heat thermal paper, (ii) a printhead thermistor to measure a printhead temperature, which corresponds to the temperature of the printhead, and (iii) an environment thermistor to measure an environment temperature, which corresponds to the temperature of the thermal paper. The method also includes the step of measuring the printhead temperature and the environment temperature and the step of comparing the two temperatures to create a compensated temperature. Finally, the method includes the step of controlling the heating of the thermal printhead using the compensated temperature.

In one possible embodiment of the method, the method further includes the steps of measuring the difference between the environment temperature and the printhead temperature and determining if the environment temperature is greater than or less than the printhead temperature.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 depicts a side view of a thermal printhead according to an exemplary embodiment of the present invention.

FIG. 2 depicts a perspective view of a thermal printer with a portion of the housing removed according to an exemplary embodiment of the present invention.

FIG. 3 depicts a flow diagram of the thermal control of a thermal printhead according to an exemplary embodiment of the present invention.

FIG. 4 depicts a flow diagram of a method for controlling the heating of a thermal printhead according to an exemplary embodiment of the present invention.

### DETAILED DESCRIPTION

Direct thermal printing (i.e., thermal printing) is a printing process, wherein a printed mark is produced by selectively heating a print medium (e.g., thermal paper). When heated above a thermal threshold, chemicals coating the print medium change color to form a mark. To ensure good print quality, it is important to selectively heat regions on the print medium above a thermal threshold but not so high as to cause neighboring regions to change color as well.

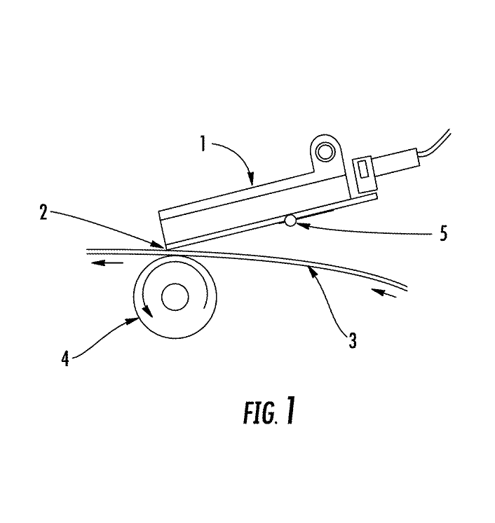

A thermal printer uses a thermal printhead (i.e., printhead) for heating. An exemplary thermal printhead is shown in FIG. 1 (i.e., FIG. 1). The thermal printhead 1 includes an array of heating elements (i.e., dots) 2. The dots may be arranged in a 2D array or a linear array (i.e., a line), and an electric current may be applied to each dot to generate heat. By moving a print medium 3 past the dots 2 (i.e., along a print-medium path shown by arrows in FIG. 1), marks may be created on the print medium 3 by selectively heating the dots in a pattern that corresponds to a line of printing. In this way letters, numbers, and/or images (e.g., barcodes) may be formed line-by-line on the print medium as the print medium moves past the heating elements 2.

It is important for print quality to control the timing of the heating/cooling of the heating elements to match the speed at which the print medium 3 moves. It is also important for print quality to control the energy applied to heat/cool the heating elements. The array of heating elements 2 may be cooled through the use of a heat sink. The heat sink insures that the heating elements are cooled sufficiently from one line of printing to the next. In some situations (e.g., fast printing, heavy printing, frequent printing, hot environments, etc.) the heat sink may not cool the heating elements 2 sufficiently. Rather than slowing or stopping the printing process to cool the heating elements 2, it is customary to adjust the energy applied to the heating elements to compensate for the increase in printhead temperature. As a result, a sensor (e.g., thermistor) is typically attached contiguously to (e.g., integrated with) the thermal printhead 1 to measure a printhead temperature. The measured printhead temperature may then be used as feedback to control the heating of the thermal printhead.

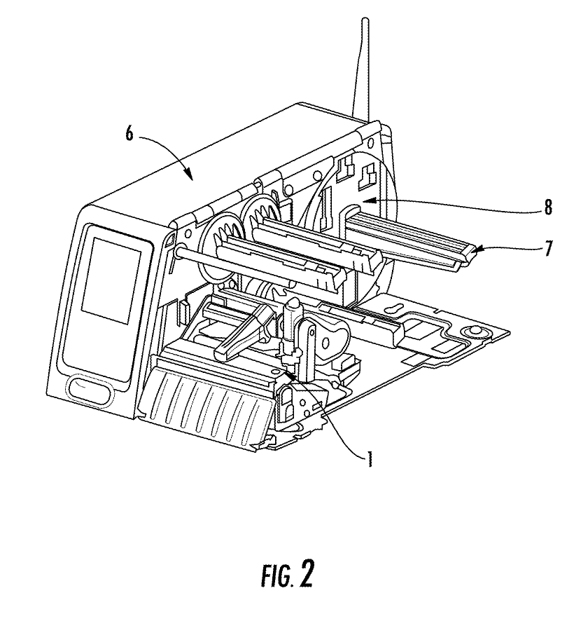

A thermal printer may also include a print-medium subsystem for holding/storing unused print medium and moving the print medium past the thermal printhead and out of the thermal printer. FIG. 2 illustrates a perspective view of a thermal printer 6 with a portion of the housing removed to show the print-medium subsystem. The print-medium subsystem may include a spool (or spindle) 7 for holding the print medium 3. The print-medium subsystem also includes a movement mechanism for moving the print medium off the spool 7 and along a print medium path. The movement mechanism may include components to direct or tension the print medium (e.g., rollers, tensioners, etc.). These components may be powered (directly or indirectly) with motors to exert force (e.g., fiction force) on the print medium and move it along the print-medium path. A platen roller 4 is typically included to insure that the print medium 3 is brought into close proximity with the array of heating elements 2. The platen roller 4 may also help move the print medium.

As mentioned previous, the energy applied to a thermal printhead's heating elements can be controlled to prevent overheating or under-heating the print medium. In addition, the control of the thermal printhead's heating is typically accomplished through the use of a temperature sensor (i.e., a printhead sensor 5) mounted directly to the thermal printhead. Using a printhead sensor 5 by itself, however, does not account for the temperature of the print medium.

The temperature of the print medium may affect print quality when there is a large difference (i.e., temperature gap) between the thermal printhead's temperature and the print-medium's temperature. For example, if the printhead is hot and the print medium is cold, then reducing the heating of the printhead may cause printing errors, since a cold print medium may require substantial energy to raise the print medium's temperature above the thermal threshold necessary for printing. Likewise, if the print medium is hot and the printhead is cold, then increasing the heating of the printhead may cause printing errors, since additional energy applied to a hot print medium may cause unwanted marks, blurred characters, and/or shading.

To address the problem described, an additional temperature sensor (i.e., environment sensor 8) may be positioned inside the thermal printer's housing to measure an environment temperature that closely corresponds to the print-medium temperature. The environment sensor 8 is typically positioned close to the print medium 2 (e.g., spaced less than 2.5 centimeters from the spool 7) and apart (e.g., spaced greater than 2.5 centimeters) from the thermal printhead 1 so that the temperature of the printhead does not substantially affect the measured environment-temperature. In this way, the measured environment-temperature is approximately (e.g., ±2.5 degrees Celsius) the temperature of the print medium.

The present invention embraces using two temperature sensors: a printhead sensor 5 contiguous to the thermal printhead 1 to monitor the temperature of the thermal printhead and an environment sensor 8 position away from the thermal printhead 1 to monitor the temperature of the environment (i.e., the approximate temperature of the print medium). In this way, the control of the heating of the thermal printhead for printing may be adjusted to compensate for differences (i.e., gaps) between the two sensed temperatures.

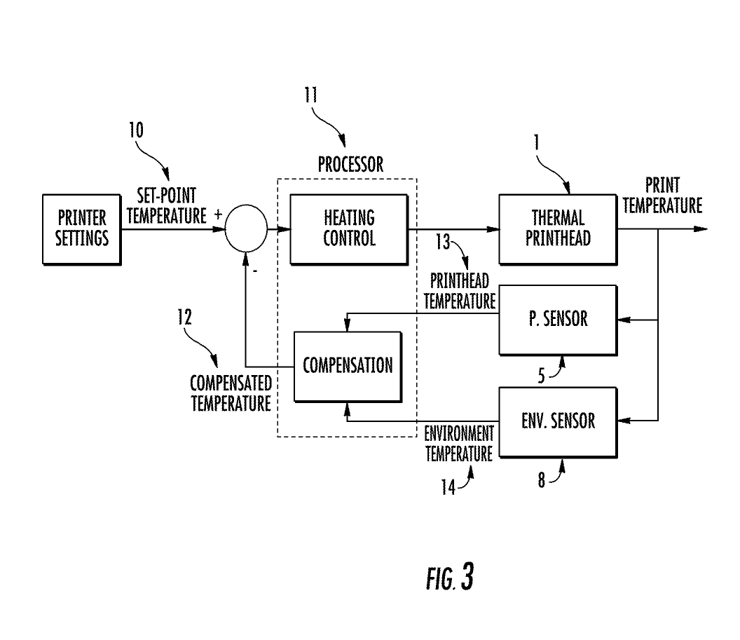

A flow diagram of an exemplary thermal (i.e., print temperature) control system embraced by the present invention is shown in FIG. 3. A set-point temperature 10 is established based on the printing conditions. Some printing conditions include (but are not limited to) the speed that the print medium moves along the print-medium path (i.e., print speed), the print-medium's type, the sensitivity (i.e., thermal threshold) of the print medium, the heat sink properties, and the dot resistance. This set-point temperature may be stored in memory based (e.g., during fabrication) or based on settings adjusted by a user. A processor 11 compares a sensed temperature to the set-point temperature 10 (e.g., recalled from memory), and then based on this comparison, adjusts the energy (e.g., current, duty cycle, etc.) applied to the thermal print head 1 (i.e., the thermal-printhead's heating elements) to minimize any difference. Typically, the sensed temperature is the printhead temperature, but as shown in FIG. 3, the present invention embraces creating a compensated temperature 12 for feedback. The compensated temperature compensates for a difference between the printhead temperature 13 and the environment temperature 14 that could otherwise lead to printing errors (i.e., low quality printing).

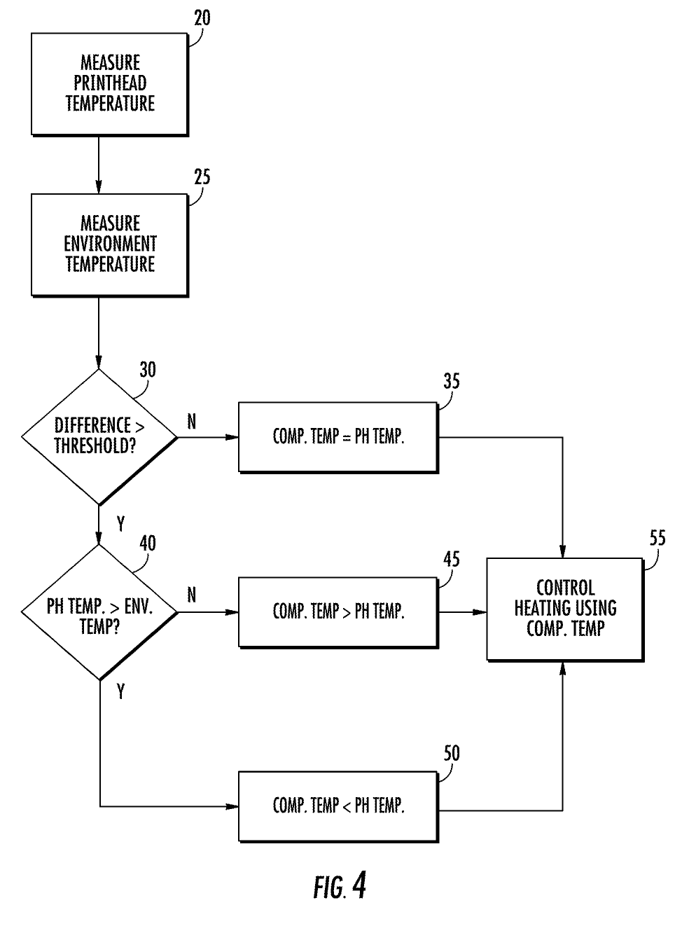

FIG. 4 depicts a flow diagram of a method for controlling the heating of a thermal printhead using a compensated temperature. The temperature of the thermal print head is measured with a printhead sensor 20, and the temperature of the environment is measured with an environment sensor 25. A processor (configured by software) then computes a temperature gap based on the difference between the printhead temperature and the environment temperature. The processor compares the temperature gap to a temperature-gap threshold 30 (e.g., 10 degrees Celsius). If the temperature gap does not exceed the threshold (i.e., the printhead temperature and the print-medium temperature are similar), then the printhead temperature may be used as feedback to control the heating of the thermal printhead 35. In other words, a compensated temperature is created that equals the printhead temperature. If the temperature-gap threshold is exceeded, however, the processor compares the printhead temperature to the environment temperature to determine which temperature is higher 40. If the environment temperature is greater than the printhead temperature, then the processor computes a compensated temperature that is greater than the printhead temperature 45. If the environment temperature is less than the printhead temperature, then the processor computes a compensated temperature that is less than the printhead temperature 50. The compensated temperature is used as feedback to control the heating of the printhead's heating elements 55.

The computation of the compensated temperature may include adding or subtracting a compensation value to the printhead temperature. The compensation value may not equal the temperature gap but typically, the compensation value has a magnitude that corresponds to the temperature gap.

As illustrated in FIG. 3, when the compensated temperature 12 is less than the set-point temperature 10, more heating is applied to the thermal printhead's heating elements. Alternatively, when the compensated temperature 12 is greater than the set-point temperature 10, less heating is applied to the thermal printhead's heating elements.

While compensated temperature has been shown to facilitate thermal control, compensated temperature may also be used to control other characteristics that affect print quality. These other characteristics may include (but are not limited to) print speed, print-head pressure, and/or set-point temperature. In addition, the detection of a large temperature gap may indicate a problem with the thermal printer. In this case, the processor may be configured to initiate other actions. These actions may include (but are not limited to) generating an error message, generating a diagnostic message, and/or halting the printing process.

To supplement the present disclosure, this application incorporates entirely by reference the following commonly assigned patents, patent application publications, and patent applications:
U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,525;
U.S. Pat. No. 8,794,526; U.S. Pat. No. 8,798,367;
U.S. Pat. No. 8,807,431; U.S. Pat. No. 8,807,432;
U.S. Pat. No. 8,820,630; U.S. Pat. No. 8,822,848;
U.S. Pat. No. 8,824,692; U.S. Pat. No. 8,824,696;
U.S. Pat. No. 8,842,849; U.S. Pat. No. 8,844,822;
U.S. Pat. No. 8,844,823; U.S. Pat. No. 8,849,019;
U.S. Pat. No. 8,851,383; U.S. Pat. No. 8,854,633;
U.S. Pat. No. 8,866,963; U.S. Pat. No. 8,868,421;
U.S. Pat. No. 8,868,519; U.S. Pat. No. 8,868,802;
U.S. Pat. No. 8,868,803; U.S. Pat. No. 8,870,074;
U.S. Pat. No. 8,879,639; U.S. Pat. No. 8,880,426;
U.S. Pat. No. 8,881,983; U.S. Pat. No. 8,881,987;
U.S. Pat. No. 8,903,172; U.S. Pat. No. 8,908,995;
U.S. Pat. No. 8,910,870; U.S. Pat. No. 8,910,875;
U.S. Pat. No. 8,914,290; U.S. Pat. No. 8,914,788;
U.S. Pat. No. 8,915,439; U.S. Pat. No. 8,915,444;
U.S. Pat. No. 8,916,789; U.S. Pat. No. 8,918,250;
U.S. Pat. No. 8,918,564; U.S. Pat. No. 8,925,818;
U.S. Pat. No. 8,939,374; U.S. Pat. No. 8,942,480;
U.S. Pat. No. 8,944,313; U.S. Pat. No. 8,944,327;
U.S. Pat. No. 8,944,332; U.S. Pat. No. 8,950,678;
U.S. Pat. No. 8,967,468; U.S. Pat. No. 8,971,346;
U.S. Pat. No. 8,976,030; U.S. Pat. No. 8,976,368;
U.S. Pat. No. 8,978,981; U.S. Pat. No. 8,978,983;
U.S. Pat. No. 8,978,984; U.S. Pat. No. 8,985,456;
U.S. Pat. No. 8,985,457; U.S. Pat. No. 8,985,459;
U.S. Pat. No. 8,985,461; U.S. Pat. No. 8,988,578;
U.S. Pat. No. 8,988,590; U.S. Pat. No. 8,991,704;
U.S. Pat. No. 8,996,194; U.S. Pat. No. 8,996,384;
U.S. Pat. No. 9,002,641; U.S. Pat. No. 9,007,368;
U.S. Pat. No. 9,010,641; U.S. Pat. No. 9,015,513;
U.S. Pat. No. 9,016,576; U.S. Pat. No. 9,022,288;
U.S. Pat. No. 9,030,964; U.S. Pat. No. 9,033,240;
U.S. Pat. No. 9,033,242; U.S. Pat. No. 9,036,054;
U.S. Pat. No. 9,037,344; U.S. Pat. No. 9,038,911;
U.S. Pat. No. 9,038,915; U.S. Pat. No. 9,047,098;
U.S. Pat. No. 9,047,359; U.S. Pat. No. 9,047,420;
U.S. Pat. No. 9,047,525; U.S. Pat. No. 9,047,531;
U.S. Pat. No. 9,053,055; U.S. Pat. No. 9,053,378;
U.S. Pat. No. 9,053,380; U.S. Pat. No. 9,058,526;
U.S. Pat. No. 9,064,165; U.S. Pat. No. 9,064,167;
U.S. Pat. No. 9,064,168; U.S. Pat. No. 9,064,254;
U.S. Pat. No. 9,066,032; U.S. Pat. No. 9,070,032;
U.S. Design Patent No. D716,285;
U.S. Design Patent No. D723,560;
U.S. Design Patent No. D730,357;
U.S. Design Patent No. D730,901;
U.S. Design Patent No. D730,902;
U.S. Design Patent No. D733,112;
U.S. Design Patent No. D734,339;
International Publication No. 2013/163789;
International Publication No. 2013/173985;
International Publication No. 2014/019130;
International Publication No. 2014/110495;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2010/0265880;
U.S. Patent Application Publication No. 2011/0202554;
U.S. Patent Application Publication No. 2012/0111946;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0287258;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0313325;
U.S. Patent Application Publication No. 2013/0342717;
U.S. Patent Application Publication No. 2014/0001267;
U.S. Patent Application Publication No. 2014/0008439;
U.S. Patent Application Publication No. 2014/0025584;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0042814;
U.S. Patent Application Publication No. 2014/0049120;
U.S. Patent Application Publication No. 2014/0049635;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0076974;
U.S. Patent Application Publication No. 2014/0078341;
U.S. Patent Application Publication No. 2014/0078345;
U.S. Patent Application Publication No. 2014/0097249;
U.S. Patent Application Publication No. 2014/0098792;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0104451;
U.S. Patent Application Publication No. 2014/0106594;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0110485;
U.S. Patent Application Publication No. 2014/0114530;
U.S. Patent Application Publication No. 2014/0124577;
U.S. Patent Application Publication No. 2014/0124579;
U.S. Patent Application Publication No. 2014/0125842;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131438;
U.S. Patent Application Publication No. 2014/0131441;
U.S. Patent Application Publication No. 2014/0131443;
U.S. Patent Application Publication No. 2014/0131444;
U.S. Patent Application Publication No. 2014/0131445;
U.S. Patent Application Publication No. 2014/0131448;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0151453;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0166755;
U.S. Patent Application Publication No. 2014/0166759;
U.S. Patent Application Publication No. 2014/0168787;
U.S. Patent Application Publication No. 2014/0175165;
U.S. Patent Application Publication No. 2014/0175172;
U.S. Patent Application Publication No. 2014/0191644;
U.S. Patent Application Publication No. 2014/0191913;
U.S. Patent Application Publication No. 2014/0197238;
U.S. Patent Application Publication No. 2014/0197239;
U.S. Patent Application Publication No. 2014/0197304;
U.S. Patent Application Publication No. 2014/0214631;
U.S. Patent Application Publication No. 2014/0217166;
U.S. Patent Application Publication No. 2014/0217180;
U.S. Patent Application Publication No. 2014/0231500;
U.S. Patent Application Publication No. 2014/0232930;
U.S. Patent Application Publication No. 2014/0247315;
U.S. Patent Application Publication No. 2014/0263493;
U.S. Patent Application Publication No. 2014/0263645;
U.S. Patent Application Publication No. 2014/0267609;
U.S. Patent Application Publication No. 2014/0270196;
U.S. Patent Application Publication No. 2014/0270229;
U.S. Patent Application Publication No. 2014/0278387;
U.S. Patent Application Publication No. 2014/0278391;
U.S. Patent Application Publication No. 2014/0282210;
U.S. Patent Application Publication No. 2014/0284384;
U.S. Patent Application Publication No. 2014/0288933;
U.S. Patent Application Publication No. 2014/0297058;
U.S. Patent Application Publication No. 2014/0299665;
U.S. Patent Application Publication No. 2014/0312121;
U.S. Patent Application Publication No. 2014/0319220;
U.S. Patent Application Publication No. 2014/0319221;
U.S. Patent Application Publication No. 2014/0326787;
U.S. Patent Application Publication No. 2014/0332590;
U.S. Patent Application Publication No. 2014/0344943;
U.S. Patent Application Publication No. 2014/0346233;
U.S. Patent Application Publication No. 2014/0351317;
U.S. Patent Application Publication No. 2014/0353373;
U.S. Patent Application Publication No. 2014/0361073;
U.S. Patent Application Publication No. 2014/0361082;
U.S. Patent Application Publication No. 2014/0362184;
U.S. Patent Application Publication No. 2014/0363015;
U.S. Patent Application Publication No. 2014/0369511;
U.S. Patent Application Publication No. 2014/0374483;
U.S. Patent Application Publication No. 2014/0374485;
U.S. Patent Application Publication No. 2015/0001301;
U.S. Patent Application Publication No. 2015/0001304;
U.S. Patent Application Publication No. 2015/0003673;
U.S. Patent Application Publication No. 2015/0009338;
U.S. Patent Application Publication No. 2015/0009610;
U.S. Patent Application Publication No. 2015/0014416;
U.S. Patent Application Publication No. 2015/0021397;
U.S. Patent Application Publication No. 2015/0028102;
U.S. Patent Application Publication No. 2015/0028103;
U.S. Patent Application Publication No. 2015/0028104;
U.S. Patent Application Publication No. 2015/0029002;
U.S. Patent Application Publication No. 2015/0032709;
U.S. Patent Application Publication No. 2015/0039309;
U.S. Patent Application Publication No. 2015/0039878;
U.S. Patent Application Publication No. 2015/0040378;
U.S. Patent Application Publication No. 2015/0048168;
U.S. Patent Application Publication No. 2015/0049347;
U.S. Patent Application Publication No. 2015/0051992;
U.S. Patent Application Publication No. 2015/0053766;
U.S. Patent Application Publication No. 2015/0053768;
U.S. Patent Application Publication No. 2015/0053769;
U.S. Patent Application Publication No. 2015/0060544;
U.S. Patent Application Publication No. 2015/0062366;
U.S. Patent Application Publication No. 2015/0063215;
U.S. Patent Application Publication No. 2015/0063676;
U.S. Patent Application Publication No. 2015/0069130;
U.S. Patent Application Publication No. 2015/0071819;
U.S. Patent Application Publication No. 2015/0083800;
U.S. Patent Application Publication No. 2015/0086114;
U.S. Patent Application Publication No. 2015/0088522;
U.S. Patent Application Publication No. 2015/0096872;
U.S. Patent Application Publication No. 2015/0099557;
U.S. Patent Application Publication No. 2015/0100196;
U.S. Patent Application Publication No. 2015/0102109;
U.S. Patent Application Publication No. 2015/0115035;
U.S. Patent Application Publication No. 2015/0127791;
U.S. Patent Application Publication No. 2015/0128116;
U.S. Patent Application Publication No. 2015/0129659;
U.S. Patent Application Publication No. 2015/0133047;
U.S. Patent Application Publication No. 2015/0134470;
U.S. Patent Application Publication No. 2015/0136851;
U.S. Patent Application Publication No. 2015/0136854;
U.S. Patent Application Publication No. 2015/0142492;
U.S. Patent Application Publication No. 2015/0144692;
U.S. Patent Application Publication No. 2015/0144698;
U.S. Patent Application Publication No. 2015/0144701;
U.S. Patent Application Publication No. 2015/0149946;
U.S. Patent Application Publication No. 2015/0161429;
U.S. Patent Application Publication No. 2015/0169925;
U.S. Patent Application Publication No. 2015/0169929;
U.S. Patent Application Publication No. 2015/0178523;
U.S. Patent Application Publication No. 2015/0178534;
U.S. Patent Application Publication No. 2015/0178535;
U.S. Patent Application Publication No. 2015/0178536;
U.S. Patent Application Publication No. 2015/0178537;
U.S. Patent Application Publication No. 2015/0181093;
U.S. Patent Application Publication No. 2015/0181109;
U.S. patent application Ser. No. 13/367,978 for a Laser Scanning Module Employing an Elastomeric U-Hinge Based Laser Scanning Assembly, filed Feb. 7, 2012 (Feng et al.);
U.S. patent application Ser. No. 29/458,405 for an Electronic Device, filed Jun. 19, 2013 (Fitch et al.);
U.S. patent application Ser. No. 29/459,620 for an Electronic Device Enclosure, filed Jul. 2, 2013 (London et al.);
U.S. patent application Ser. No. 29/468,118 for an Electronic Device Case, filed Sep. 26, 2013 (Oberpriller et al.);
U.S. patent application Ser. No. 14/150,393 for Indicia-reader Having Unitary Construction Scanner, filed Jan. 8, 2014 (Colavito et al.);
U.S. patent application Ser. No. 14/200,405 for Indicia Reader for Size-Limited Applications filed Mar. 7, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application Ser. No. 29/486,759 for an Imaging Terminal, filed Apr. 2, 2014 (Oberpriller et al.);
U.S. patent application Ser. No. 14/257,364 for Docking System and Method Using Near Field Communication filed Apr. 21, 2014 (Showering);
U.S. patent application Ser. No. 14/264,173 for Autofocus Lens System for Indicia Readers filed Apr. 29, 2014 (Ackley et al.);
U.S. patent application Ser. No. 14/277,337 for MULTIPURPOSE OPTICAL READER, filed May 14, 2014 (Jovanovski et al.);
U.S. patent application Ser. No. 14/283,282 for TERMINAL HAVING ILLUMINATION AND FOCUS CONTROL filed May 21, 2014 (Liu et al.);
U.S. patent application Ser. No. 14/327,827 for a MOBILE-PHONE ADAPTER FOR ELECTRONIC TRANSACTIONS, filed Jul. 10, 2014 (Hejl);
U.S. patent application Ser. No. 14/334,934 for a SYSTEM AND METHOD FOR INDICIA VERIFICATION, filed Jul. 18, 2014 (Hejl);
U.S. patent application Ser. No. 14/339,708 for LASER SCANNING CODE SYMBOL READING SYSTEM, filed Jul. 24, 2014 (Xian et al.);
U.S. patent application Ser. No. 14/340,627 for an AXIALLY REINFORCED FLEXIBLE SCAN ELEMENT, filed Jul. 25, 2014 (Rueblinger et al.);
U.S. patent application Ser. No. 14/446,391 for MULTIFUNCTION POINT OF SALE APPARATUS WITH OPTICAL SIGNATURE CAPTURE filed Jul. 30, 2014 (Good et al.);
U.S. patent application Ser. No. 14/452,697 for INTERACTIVE INDICIA READER, filed Aug. 6, 2014 (Todeschini);
U.S. patent application Ser. No. 14/453,019 for DIMENSIONING SYSTEM WITH GUIDED ALIGNMENT, filed Aug. 6, 2014 (Li et al.);
U.S. patent application Ser. No. 14/462,801 for MOBILE COMPUTING DEVICE WITH DATA COGNITION SOFTWARE, filed on Aug. 19, 2014 (Todeschini et al.);
U.S. patent application Ser. No. 14/483,056 for VARIABLE DEPTH OF FIELD BARCODE SCANNER filed Sep. 10, 2014 (McCloskey et al.);
U.S. patent application Ser. No. 14/513,808 for IDENTIFYING INVENTORY ITEMS IN A STORAGE FACILITY filed Oct. 14, 2014 (Singel et al.);
U.S. patent application Ser. No. 14/519,195 for HANDHELD DIMENSIONING SYSTEM WITH FEEDBACK filed Oct. 21, 2014 (Laffargue et al.);
U.S. patent application Ser. No. 14/519,179 for DIMENSIONING SYSTEM WITH MULTIPATH INTERFERENCE MITIGATION filed Oct. 21, 2014 (Thuries et al.);
U.S. patent application Ser. No. 14/519,211 for SYSTEM AND METHOD FOR DIMENSIONING filed Oct. 21, 2014 (Ackley et al.);
U.S. patent application Ser. No. 14/519,233 for HANDHELD DIMENSIONER WITH DATA-QUALITY INDICATION filed Oct. 21, 2014 (Laffargue et al.);
U.S. patent application Ser. No. 14/519,249 for HANDHELD DIMENSIONING SYSTEM WITH MEASUREMENT-CONFORMANCE FEEDBACK filed Oct. 21, 2014 (Ackley et al.); U.S. patent application Ser. No. 14/527,191 for METHOD AND SYSTEM FOR RECOGNIZING SPEECH USING WILDCARDS IN AN EXPECTED RESPONSE filed Oct. 29, 2014 (Braho et al.); U.S. patent application Ser. No. 14/529,563 for ADAPTABLE INTERFACE FOR A MOBILE COMPUTING DEVICE filed Oct. 31, 2014 (Schoon et al.); U.S. patent application Ser. No. 14/529,857 for BARCODE READER WITH SECURITY FEATURES filed Oct. 31, 2014 (Todeschini et al.);
U.S. patent application Ser. No. 14/398,542 for PORTABLE ELECTRONIC DEVICES HAVING A SEPARATE LOCATION TRIGGER UNIT FOR USE IN CONTROLLING AN APPLICATION UNIT filed Nov. 3, 2014 (Bian et al.);
U.S. patent application Ser. No. 14/531,154 for DIRECTING AN INSPECTOR THROUGH AN INSPECTION filed Nov. 3, 2014 (Miller et al.);
U.S. patent application Ser. No. 14/533,319 for BARCODE SCANNING SYSTEM USING WEARABLE DEVICE WITH EMBEDDED CAMERA filed Nov. 5, 2014 (Todeschini);
U.S. patent application Ser. No. 14/535,764 for CONCATENATED EXPECTED RESPONSES FOR SPEECH RECOGNITION filed Nov. 7, 2014 (Braho et al.);
U.S. patent application Ser. No. 14/568,305 for AUTO-CONTRAST VIEWFINDER FOR AN INDICIA READER filed Dec. 12, 2014 (Todeschini);
U.S. patent application Ser. No. 14/573,022 for DYNAMIC DIAGNOSTIC INDICATOR GENERATION filed Dec. 17, 2014 (Goldsmith);
U.S. patent application Ser. No. 14/578,627 for SAFETY SYSTEM AND METHOD filed Dec. 22, 2014 (Ackley et al.);
U.S. Patent Application No. 14/580,262 for MEDIA GATE FOR THERMAL TRANSFER PRINTERS filed Dec. 23, 2014 (Bowles);
U.S. patent application Ser. No. 14/590,024 for SHELVING AND PACKAGE LOCATING SYSTEMS FOR DELIVERY VEHICLES filed Jan. 6, 2015 (Payne);
U.S. patent application Ser. No. 14/596,757 for SYSTEM AND METHOD FOR DETECTING BARCODE PRINTING ERRORS filed Jan. 14, 2015 (Ackley);
U.S. patent application Ser. No. 14/416,147 for OPTICAL READING APPARATUS HAVING VARIABLE SETTINGS filed Jan. 21, 2015 (Chen et al.);
U.S. patent application Ser. No. 14/614,706 for DEVICE FOR SUPPORTING AN ELECTRONIC TOOL ON A USER'S HAND filed Feb. 5, 2015 (Oberpriller et al.);
U.S. patent application Ser. No. 14/614,796 for CARGO APPORTIONMENT TECHNIQUES filed Feb. 5, 2015 (Morton et al.);
U.S. patent application Ser. No. 29/516,892 for TABLE COMPUTER filed Feb. 6, 2015 (Bidwell et al.);
U.S. patent application Ser. No. 14/619,093 for METHODS FOR TRAINING A SPEECH RECOGNITION SYSTEM filed Feb. 11, 2015 (Pecorari);
U.S. patent application Ser. No. 14/628,708 for DEVICE, SYSTEM, AND METHOD FOR DETERMINING THE STATUS OF CHECKOUT LANES filed Feb. 23, 2015 (Todeschini);
U.S. patent application Ser. No. 14/630,841 for TERMINAL INCLUDING IMAGING ASSEMBLY filed Feb. 25, 2015 (Gomez et al.);
U.S. patent application Ser. No. 14/635,346 for SYSTEM AND METHOD FOR RELIABLE STORE-AND-FORWARD DATA HANDLING BY ENCODED INFORMATION READING TERMINALS filed Mar. 2, 2015 (Sevier);
U.S. patent application Ser. No. 29/519,017 for SCANNER filed Mar. 2, 2015 (Zhou et al.);
U.S. patent application Ser. No. 14/405,278 for DESIGN PATTERN FOR SECURE STORE filed Mar. 9, 2015 (Zhu et al.);
U.S. patent application Ser. No. 14/660,970 for DECODABLE INDICIA READING TERMINAL WITH COMBINED ILLUMINATION filed Mar. 18, 2015 (Kearney et al.);
U.S. patent application Ser. No. 14/661,013 for REPROGRAMMING SYSTEM AND METHOD FOR DEVICES INCLUDING PROGRAMMING SYMBOL filed Mar. 18, 2015 (Soule et al.);
U.S. patent application Ser. No. 14/662,922 for MULTIFUNCTION POINT OF SALE SYSTEM filed Mar. 19, 2015 (Van Horn et al.);
U.S. patent application Ser. No. 14/663,638 for VEHICLE MOUNT COMPUTER WITH CONFIGURABLE IGNITION SWITCH BEHAVIOR filed Mar. 20, 2015 (Davis et al.);
U.S. patent application Ser. No. 14/664,063 for METHOD AND APPLICATION FOR SCANNING A BARCODE WITH A SMART DEVICE WHILE CONTINUOUSLY RUNNING AND DISPLAYING AN APPLICATION ON THE SMART DEVICE DISPLAY filed Mar. 20, 2015 (Todeschini);
U.S. patent application Ser. No. 14/669,280 for TRANSFORMING COMPONENTS OF A WEB PAGE TO VOICE PROMPTS filed Mar. 26, 2015 (Funyak et al.);
U.S. patent application Ser. No. 14/674,329 for AIMER FOR BARCODE SCANNING filed Mar. 31, 2015 (Bidwell);
U.S. patent application Ser. No. 14/676,109 for INDICIA READER filed Apr. 1, 2015 (Huck);
U.S. patent application Ser. No. 14/676,327 for DEVICE MANAGEMENT PROXY FOR SECURE DEVICES filed Apr. 1, 2015 (Yeakley et al.);
U.S. patent application Ser. No. 14/676,898 for NAVIGATION SYSTEM CONFIGURED TO INTEGRATE MOTION SENSING DEVICE INPUTS filed Apr. 2, 2015 (Showering);
U.S. patent application Ser. No. 14/679,275 for DIMENSIONING SYSTEM CALIBRATION SYSTEMS AND METHODS filed Apr. 6, 2015 (Laffargue et al.);
U.S. patent application Ser. No. 29/523,098 for HANDLE FOR A TABLET COMPUTER filed Apr. 7, 2015 (Bidwell et al.);
U.S. patent application Ser. No. 14/682,615 for SYSTEM AND METHOD FOR POWER MANAGEMENT OF MOBILE DEVICES filed Apr. 9, 2015 (Murawski et al.);
U.S. patent application Ser. No. 14/686,822 for MULTIPLE PLATFORM SUPPORT SYSTEM AND METHOD filed Apr. 15, 2015 (Qu et al.);
U.S. patent application Ser. No. 14/687,289 for SYSTEM FOR COMMUNICATION VIA A PERIPHERAL HUB filed Apr. 15, 2015 (Kohtz et al.);
U.S. patent application Ser. No. 29/524,186 for SCANNER filed Apr. 17, 2015 (Zhou et al.);
U.S. patent application Ser. No. 14/695,364 for MEDICATION MANAGEMENT SYSTEM filed Apr. 24, 2015 (Sewell et al.);
U.S. patent application Ser. No. 14/695,923 for SECURE UNATTENDED NETWORK AUTHENTICATION filed Apr. 24, 2015 (Kubler et al.);
U.S. patent application Ser. No. 29/525,068 for TABLET COMPUTER WITH REMOVABLE SCANNING DEVICE filed Apr. 27, 2015 (Schulte et al.);
U.S. patent application Ser. No. 14/699,436 for SYMBOL READING SYSTEM HAVING PREDICTIVE DIAGNOSTICS filed Apr. 29, 2015 (Nahill et al.);
U.S. patent application Ser. No. 14/702,110 for SYSTEM AND METHOD FOR REGULATING BARCODE DATA INJECTION INTO A RUNNING APPLICATION ON A SMART DEVICE filed May 1, 2015 (Todeschini et al.);
U.S. patent application Ser. No. 14/702,979 for TRACKING BATTERY CONDITIONS filed May 4, 2015 (Young et al.);
U.S. patent application Ser. No. 14/704,050 for INTERMEDIATE LINEAR POSITIONING filed May 5, 2015 (Charpentier et al.);
U.S. patent application Ser. No. 14/705,012 for HANDS-FREE HUMAN MACHINE INTERFACE RESPONSIVE TO A DRIVER OF A VEHICLE filed May 6, 2015 (Fitch et al.);
U.S. patent application Ser. No. 14/705,407 for METHOD AND SYSTEM TO PROTECT SOFTWARE-BASED NETWORK-CONNECTED DEVICES FROM ADVANCED PERSISTENT THREAT filed May 6, 2015 (Hussey et al.);
U.S. patent application Ser. No. 14/707,037 for SYSTEM AND METHOD FOR DISPLAY OF INFORMATION USING A VEHICLE-MOUNT COMPUTER filed May 8, 2015 (Chamberlin);
U.S. patent application Ser. No. 14/707,123 for APPLICATION INDEPENDENT DEX/UCS INTERFACE filed May 8, 2015 (Pape);
U.S. patent application Ser, No. 14/707,492 for METHOD AND APPARATUS FOR READING OPTICAL INDICIA USING A PLURALITY OF DATA SOURCES filed May 8, 2015 (Smith et al.);
U.S. patent application Ser. No. 14/710,666 for PRE-PAID USAGE SYSTEM FOR ENCODED INFORMATION READING TERMINALS filed May 13, 2015 (Smith);
U.S. patent application Ser. No. 29/526,918 for CHARGING BASE filed May 14, 2015 (Fitch et al.);
U.S. patent application Ser. No. 14/715,672 for AUGUMENTED REALITY ENABLED HAZARD DISPLAY filed May 19, 2015 (Venkatesha et al.);
U.S. patent application Ser. No. 14/715,916 for EVALUATING IMAGE VALUES filed May 19, 2015 (Ackley);
U.S. patent application Ser. No. 14/722,608 for INTERACTIVE USER INTERFACE FOR CAPTURING A DOCUMENT IN AN IMAGE SIGNAL filed May 27, 2015 (Showering et al.);
U.S. patent application Ser. No. 29/528,165 for IN-COUNTER BARCODE SCANNER filed May 27, 2015 (Oberpriller et al.);
U.S. patent application Ser. No. 14/724,134 for ELECTRONIC DEVICE WITH WIRELESS PATH SELECTION CAPABILITY filed May 28, 2015 (Wang et al.);
U.S. patent application Ser. No. 14/724,849 for METHOD OF PROGRAMMING THE DEFAULT CABLE INTERFACE SOFTWARE IN AN INDICIA READING DEVICE filed May 29, 2015 (Barten);
U.S. patent application Ser. No. 14/724,908 for IMAGING APPARATUS HAVING IMAGING ASSEMBLY filed May 29, 2015 (Barber et al.);
U.S. patent application Ser. No. 14/725,352 for APPARATUS AND METHODS FOR MONITORING ONE OR MORE PORTABLE DATA TERMINALS (Caballero et al.);
U.S. patent application Ser. No. 29/528,590 for ELECTRONIC DEVICE filed May 29, 2015 (Fitch et al.);
U.S. patent application Ser. No. 29/528,890 for MOBILE COMPUTER HOUSING filed Jun. 2, 2015 (Fitch et al.);
U.S. patent application Ser. No. 14/728,397 for DEVICE MANAGEMENT USING VIRTUAL INTERFACES CROSS-REFERENCE TO RELATED APPLICATIONS filed Jun. 2, 2015 (Caballero);
U.S. patent application Ser. No. 14/732,870 for DATA COLLECTION MODULE AND SYSTEM filed Jun. 8, 2015 (Powilleit);
U.S. patent application Ser. No. 29/529,441 for INDICIA READING DEVICE filed Jun. 8, 2015 (Zhou et al.);
U.S. patent application Ser. No. 14/735,717 for INDICIA-READING SYSTEMS HAVING AN INTERFACE WITH A USER'S NERVOUS SYSTEM filed Jun. 10, 2015 (Todeschini);
U.S. patent application Ser. No. 14/738,038 for METHOD OF AND SYSTEM FOR DETECTING OBJECT WEIGHING INTERFERENCES filed Jun. 12, 2015 (Amundsen et al.);
U.S. patent application Ser. No. 14/740,320 for TACTILE SWITCH FOR A MOBILE ELECTRONIC DEVICE filed Jun. 16, 2015 (Bandringa);
U.S. patent application Ser. No. 14/740,373 for CALIBRATING A VOLUME DIMENSIONER filed Jun. 16, 2015 (Ackley et al.);
U.S. patent application Ser. No. 14/742,818 for INDICIA READING SYSTEM EMPLOYING DIGITAL GAIN CONTROL filed Jun. 18, 2015 (Xian et al.);
U.S. patent application Ser. No. 14/743,257 for WIRELESS MESH POINT PORTABLE DATA TERMINAL filed Jun. 18, 2015 (Wang et al.);
U.S. patent application Ser. No. 29/530,600 for CYCLONE filed Jun. 18, 2015 (Vargo et al);
U.S. patent application Ser. No. 14/744,633 for IMAGING APPARATUS COMPRISING IMAGE SENSOR ARRAY HAVING SHARED GLOBAL SHUTTER CIRCUITRY filed Jun. 19, 2015 (Wang);
U.S. patent application Ser. No. 14/744,836 for CLOUD-BASED SYSTEM FOR READING OF DECODABLE INDICIA filed Jun. 19, 2015 (Todeschini et al.);
U.S. patent application Ser. No. 14/745,006 for SELECTIVE OUTPUT OF DECODED MESSAGE DATA filed Jun. 19, 2015 (Todeschini et al.);
U.S. patent application Ser. No. 14/747,197 for OPTICAL PATTERN PROJECTOR filed Jun. 23, 2015 (Thuries et al.);
U.S. patent application Ser. No. 14/747,490 for DUAL-PROJECTOR THREE-DIMENSIONAL SCANNER filed Jun. 23, 2015 (Jovanovski et al.); and
U.S. patent application Ser. No. 14/748,446 for CORDLESS INDICIA READER WITH A MULTIFUNCTION COIL FOR WIRELESS CHARGING AND EAS DEACTIVATION, filed Jun. 24, 2015 (Xie et al.).

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A thermal printer, comprising:
a thermal printhead;
a print-medium subsystem comprising a spool for holding a print medium and a movement mechanism for moving the print medium along a print-medium path so that the print medium may be heated by the thermal printhead;
a housing encompassing the thermal printhead and the print-medium subsystem;
a first sensor mounted to the thermal printhead for sensing a printhead temperature;
a second sensor positioned within the housing and apart from the thermal printhead for sensing an environment temperature; and
a processor contained in the housing and communicatively coupled to the thermal printhead, the first sensor, and the second sensor, wherein the processor is configured by software to:
compare the environment temperature and the printhead temperature,
compute a temperature value based on the comparison, and
control the heating of the thermal printhead using the temperature value.

2. The thermal printer according to claim 1, wherein the control of the heating of the thermal printhead based on the temperature value comprises adjusting the energy applied to heating elements to minimize a difference between the temperature value and a set-point temperature.

3. The thermal printer according to claim 2, wherein the set-point temperature corresponds to characteristics of the print-medium subsystem and/or the print medium.

4. The thermal printer according to claim 3, wherein the characteristics of the print-medium subsystem and/or the print medium include (i) a speed at which the print medium moves along the print-medium path and/or (ii) a thermal sensitivity of the print-medium.

5. The thermal printer according to claim 1, wherein the second sensor is positioned proximate to the spool.

6. The thermal printer according to claim 1, wherein environment temperature is approximately the temperature of the print medium.

7. The thermal printer according to claim 1, wherein the print medium is thermal paper.

8. The thermal printer according to claim 1, wherein the first sensor and the second sensor are thermistors.

9. The thermal printer according to claim 1, wherein comparing the environment temperature to the printhead temperature comprises calculating a temperature gap that is a difference between the environment temperature and the printhead temperature.

10. The thermal printer according to claim 9, wherein if the temperature gap is below a temperature-gap threshold, then the processor computes a temperature value that equals the printhead temperature.

11. The thermal printer according to claim 9, wherein if the temperature gap is above a temperature-gap threshold and the environment temperature is greater than the printhead temperature, then the processor computes a temperature value by adding a compensation value to the printhead temperature.

12. The thermal printer according to claim 9, wherein if the temperature gap is above a temperature-gap threshold and the environment temperature is less than the printhead temperature, then the processor computes a temperature value by subtracting a compensation value from the printhead temperature.

13. A control system for a thermal printer, comprising:
a first sensor to measure a printhead temperature;
a second sensor to measure an environment temperature; and
a processor communicatively coupled to the first sensor and the second sensor that is configured by software to:
compare the environment temperature and the printhead temperature,
compute a temperature value based on the comparison, and
adjust the energy applied to the thermal printer's printhead using the temperature value.

14. The control system for a thermal printer according to claim 13, wherein the comparison comprises computing a temperature gap that is a difference between the environment temperature and the printhead temperature.

15. The control system for a thermal printer according to claim 14, wherein the temperature value is computed to equal the printhead temperature if the temperature gap is below a temperature-gap threshold.

16. The control system for a thermal printer according to claim 14, wherein the temperature value is computed to not equal the printhead temperature if the temperature gap is above a temperature-gap threshold.

17. The control system for a thermal printer according to claim 16, wherein the temperature value is computed to be greater than the printhead temperature if the environment temperature is greater than the printhead temperature.

18. The control system for a thermal printer according to claim 16, wherein the temperature value is computed to be less than the printhead temperature if the environment temperature is less than the printhead temperature.

19. A method, comprising:
providing a thermal printer comprising (i) a thermal printhead to heat thermal paper, (ii) a printhead thermistor to measure a printhead temperature corresponding to the temperature of the printhead, and (iii) an environment thermistor to measure an environment temperature corresponding to the temperature of the thermal paper;
measuring, with a first sensor, a printhead temperature;
measuring, with a second sensor, an environment temperature;
comparing, with a processor communicatively connected to the first sensor and the second sensor, the printhead temperature to the environment temperature to create a temperature value; and
heating a thermal printhead communicatively connected to the processor based on the temperature value.

20. The method of claim 19, wherein comparing the printhead temperature to the environment temperature to create a temperature value comprises:
measuring a difference between the environment temperature and the printhead temperature; and
determining if the environment temperature is greater than or less than the printhead temperature.
